(19) United States
(12) Patent Application Publication
(10) Pub. No.: US 2025/0101299 A1
(43) Pub. Date: Mar. 27, 2025

(54) QUANTUM DOT, METHOD OF MANUFACTURING THE SAME, AND ELECTRONIC APPARATUS INCLUDING THE SAME

(71) Applicant: Samsung Display Co., Ltd., Yongin-si (KR)

(72) Inventors: Youngsik KIM, Yongin-si (KR); Sungjae KIM, Yongin-si (KR); Hongrae KIM, Yongin-si (KR); Bitna YOON, Yongin-si (KR); Donghee LEE, Yongin-si (KR); Taekjoon LEE, Yongin-si (KR); Junehyuk JUNG, Yongin-si (KR)

(73) Assignee: Samsung Display Co., Ltd., Yongin-si (KR)

(21) Appl. No.: 18/889,807

(22) Filed: Sep. 19, 2024

(30) Foreign Application Priority Data
Sep. 21, 2023 (KR) 10-2023-0126407
Aug. 21, 2024 (KR) 10-2024-0112330

(51) Int. Cl. C09K 11/62; B82Y 20/00; B82Y 40/00; C01G 15/00; G02F 1/13357

(52) U.S. Cl. CPC C09K 11/626; C01G 15/006; G02F 1/133617; B82Y 20/00; B82Y 40/00; C01P 2002/54; C01P 2004/04; C01P 2004/64; C01P 2006/60

(57) ABSTRACT

A quantum dot includes copper (Cu), a Group III element, and a Group VI element, wherein the quantum dot further includes a halogen component that is an iodide ion, a bromide ion, a chloride ion, a fluoride ion, or a combination thereof. A molar ratio of the halogen component to the copper (Cu) and a molar ratio of the halogen component to the Group III element is each independently in a range of about 0.01 to about 0.5, and a full width at half maximum (FWHM) of a photoluminescence spectrum of the quantum dot is equal to or less than about 80 nm.

### CROSS-REFERENCE TO RELATED APPLICATION(S)

This application claims priority to and benefits of Korean Patent Application Nos. 10-2023-0126407 and 10-2024-0112330 under 35 U.S.C. § 119, respectively filed on Sep. 21, 2023 and Aug. 21, 2024 in the Korean Intellectual Property Office, the entire contents of which are incorporated herein by reference.

### BACKGROUND

### 1. Technical Field

One or more embodiments relate to a quantum dot, a method of manufacturing the quantum dot, and an electronic apparatus including the quantum dot.

### 2. Description of the Related Art

Quantum dots are nanocrystals of a semiconductor material and are materials that exhibit a quantum confinement effect. In case that quantum dots receive light from an excitation source to reach an energy excited state, the quantum dots spontaneously emit energy according to a corresponding energy band gap. Thus, quantum dots exhibit characteristics of having wavelengths that vary with particle size, even for a same material. Accordingly, the size of quantum dots may be adjusted to obtain light in a desired wavelength range, and characteristics such as excellent color purity and high luminescence efficiency may be exhibited. Therefore, quantum dots are applicable to various devices and apparatuses.

### SUMMARY

Embodiments include a quantum dot having a narrow full width at half maximum (FWHM) and a controlled emission wavelength, a method of manufacturing the quantum dot, and an electronic apparatus including the quantum dot.

However, embodiments are not limited to those set forth herein. The above and other embodiments will become more apparent to one of ordinary skill in the art to which the disclosure pertains by referencing the detailed description of the disclosure given below.

According to embodiments, a quantum dot may include copper (Cu), a Group Ill element, and a Group VI element, wherein the quantum dot may further include a halogen component that is an iodide ion, a bromide ion, a chloride ion, a fluoride ion, or a combination thereof, a molar ratio of the halogen component to the Cu and a molar ratio of the halogen component to the Group III element may each independently be in a range of about 0.01 to about 0.5, and a full width at half maximum (FWHM) of a photoluminescence spectrum of the quantum dot may be equal to or less than about 80 nm.

In an embodiment, the Group III element may be aluminum (Al), gallium (Ga), indium (In), thallium (TI), nihonium (Nh), or a combination thereof.

In an embodiment, the Group VI element may be sulfur(S), selenium (Se), tellurium (Te), or a combination thereof.

In an embodiment, the halogen component may include at least two halogen ions selected from an iodide ion, a bromide ion, a chloride ion, and a fluoride ion.

In an embodiment, a molar ratio of the halogen component to the Cu may be in a range of about 0.02 to about 0.4.

In an embodiment, a molar ratio of the halogen component to the Group III element may be in a range of about 0.02 to about 0.5.

In an embodiment, the quantum dot may include copper (Cu), indium (In), gallium (Ga), and sulfur(S).

In an embodiment, with respect to a total weight of the quantum dot, an amount of the Cu may be in a range of about 10 wt % to about 40 wt %, an amount of the In may be in a range of about 10 wt % to about 30 wt %, an amount of the Ga may be in a range of about 10 wt % to about 60 wt %, and an amount of the S may be in a range of about 30 wt % to about 60 wt %.

In an embodiment, a maximum emission wavelength of the photoluminescence spectrum of the quantum dot may be in a range of about 500 nm to about 750 nm.

In an embodiment, a maximum emission wavelength of the photoluminescence spectrum of the quantum dot may be in a range of about 585 nm to about 750 nm.

In an embodiment, the FWHM of the photoluminescence spectrum of the quantum dot may be equal to or less than about 65 nm.

According to embodiments, a method of preparing a quantum dot may include: providing a metal precursor solution including a copper halide, a Group III element halide, and a solvent; injecting a precursor of a Group VI element into the metal precursor solution; and preparing a quantum dot including copper, a Group III element, and a Group VI element by reacting the metal precursor solution into which the precursor of the Group VI element is injected, wherein the halides in the copper halide and the Group III element halide may each independently be an iodide ion, a bromide ion, a chloride ion, or a fluoride ion such that the quantum dot may exhibit a photoluminescence spectrum having a maximum emission wavelength in a range of about 500 nm to about 750 nm and a full width at half maximum (FWHM) equal to or less than about 80 nm, and a molar ratio of a halide component to the copper of the quantum dot and a molar ratio of a halide component to the Group III element of the quantum dot may each independently be in a range of about 0.01 to about 0.5.

In an embodiment, the Group III element halide may include two Group III element halides, each comprising a different Group III element.

In an embodiment, the two Group III element halides may be an indium (In) halide and a gallium halide, respectively, and the Group VI element may be sulfur(S), selenium (Se), tellurium (Te), or a combination thereof.

In an embodiment, a maximum emission wavelength of the photoluminescence spectrum of the quantum dot may be in a range of about 585 nm and about 750 nm.

In an embodiment, the FWHM of the photoluminescence spectrum of the quantum dot may be equal to or less than about 65 nm.

In an embodiment, the quantum dot may include copper (Cu), indium (In), gallium (Ga), and sulfur(S).

According to embodiments, an electronic apparatus may include the quantum dot.

In an embodiment, the electronic apparatus may further include a light source, and a color conversion member disposed on a path of light emitted from the light source, wherein the color conversion member may include the quantum dot.

### BRIEF DESCRIPTION OF THE DRAWINGS

The above and other aspects, features, and advantages of certain embodiments will be more apparent from the following description taken in conjunction with the accompanying drawings, in which:

FIG. 1 is a schematic cross-sectional view illustrating a structure of an electronic apparatus according to an embodiment;

FIG. 2 is a schematic cross-sectional view illustrating a structure of a light-emitting device according to an embodiment;

FIG. 3 is a graph showing photoluminescence (PL) spectra of CuInGaS₂ quantum dots of Comparative Test Examples 1 to 4;

FIG. 4 is a graph showing intensity and a peak position of the PL spectra of FIG. 3 according to a composition ratio (molar ratio) of Ga to In+Ga in the quantum dots;

FIG. 5 shows PL spectra of CuInGaS₂ quantum dots of Test Examples 1 to 5;

FIG. 6 shown PL spectra of CuInGaS₂ quantum dots of Test Examples 6 to 9;

FIG. 7 is a graph showing a maximum emission wavelength and a full width at half maximum (FWHM) of the PL spectra of Test Examples 6 to 9 for a set of metal precursors; and

FIGS. 8A to 8C show transmission electron microscope (TEM) images of CuInGaS₂ quantum dots of Test Examples 7 to 9, respectively.

### DETAILED DESCRIPTION OF THE EMBODIMENTS

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the FIGS., to explain aspects. As used herein, the term “and/or” includes any and all combinations of one or more of the associated listed items. Expressions such as “at least one of,” in case that preceding a list of elements, modify the entire list of elements and do not modify the individual elements of the list.

Since the disclosure can apply various transformations and have various embodiments, specific embodiments will be illustrated in the drawings and described in detail in the detailed description. Effects and features of the disclosure, and methods for achieving them will become clear with reference to the embodiments described below in detail together with the drawings. However, the disclosure is not limited to the embodiments disclosed below and may be implemented in various forms.

Hereinafter, embodiments of the disclosure will be described in detail with reference to the attached drawings. In case that describing with reference to the drawings, identical or corresponding components are given the same drawing reference numerals and redundant descriptions thereof are omitted.

In the following embodiments, the expressions used in the singular such as “a,” “an,” and “the” are intended to include the plural forms as well, unless the context clearly indicates otherwise.

In the following embodiments, it will be understood that the terms such as “including,” “comprising,” and “having” specify the presence of stated features or components, but do not preclude the presence or addition of one or more other features or components.

In the following embodiments, it will be understood that in case that an element such as a layer, film, region, or substrate is referred to as being “on” another element, it can be directly on the other element or intervening elements may also be present.

In the drawings, components may be exaggerated or reduced in size for convenience of description. For example, the sizes and thicknesses of the respective components shown in the drawings are arbitrarily shown for convenience of description, and thus embodiments are not limited thereto.

In the specification, the term “Group II elements” may encompass Group IIA elements and Group IIB elements of the International Union of Pure and Applied Chemistry (“IUPAC”) periodic table. Examples of a Group II element may include magnesium zinc (Zn), cadmium (Cd), mercury (Hg), and copernicium (Cn), but embodiments are not limited thereto.

In the specification, the term “Group III elements” may encompass Group IIIA elements and Group IIIB elements in the IUPAC periodic table. Examples of a Group III element may include aluminum (Al), indium (In), gallium (Ga), thallium (TI), and nihonium (Nh), but embodiments are not limited thereto.

In the specification, the term “Group V elements” may encompass Group VA elements and Group VB elements in the IUPAC periodic table. Examples of a Group V element may include nitrogen (N), phosphorus (P), and arsenic (As), but embodiments are not limited thereto.

In the specification, the term “Group VI elements” may encompass Group VIA elements and Group VIB elements in the IUPAC periodic table. Examples of a Group VI element may include oxygen (O), sulfur(S), selenium (Se), and tellurium (Te), but embodiments are not limited thereto.

### [Quantum Dot]

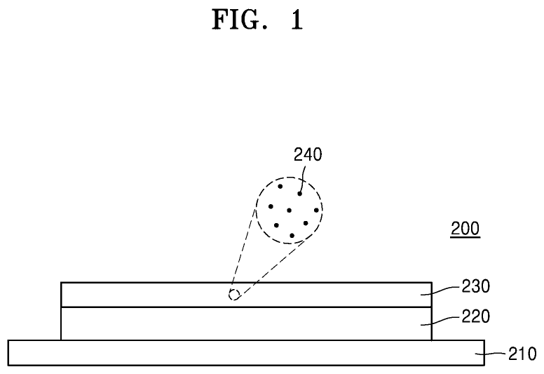

According to an embodiment, a quantum dot (e.g., 240 in FIG. 1) may include copper (Cu), a Group III element, and a Group VI element.

The quantum dot 240 may further include a halogen component that is an iodide ion, a bromide ion, a chloride ion, a fluoride ion, or a combination thereof.

A molar ratio of the halogen component to copper (Cu) and a molar ratio of the halogen component to the Group III element may each independently be in a range of about 0.01 to about 0.5.

A full width at half maximum (FWHM) of a photoluminescence (PL) spectrum of the quantum dot 240 may be equal to or less than about 80 nm.

According to embodiments, the components of the quantum dot 240 may be copper, the Group III element, and the Group VI element, and the halogen component may be derived from a metal halide that is a metal precursor in a process of preparing a quantum dot.

In an embodiment, the Group III element may be aluminum (AI), gallium (Ga), indium (In), thallium (TI), nihonium (Nh), or any combination thereof.

In an embodiment, the quantum dot 240 may include two types of Group III elements.

In an embodiment, the Group III element may include a combination of gallium (Ga) and indium (In).

In an embodiment, the Group VI element may be sulfur(S), selenium (Se), tellurium (Te), or any combination thereof.

In an embodiment, the Group VI element may be sulfur(S).

In an embodiment, the halogen component may include at least two halogen ions selected from an iodide ion, a bromide ion, a chloride ion, and a fluoride ion.

In an embodiment, the halogen component may be present (or disposed) on a surface of the quantum dot.

In an embodiment, the molar ratio of the halogen component to copper may be in a range of about 0.01 to about 0.5. For example, the molar ratio of the halogen component to copper may be in a range of about 0.02 to about 0.4. For example, the molar ratio of the halogen component to copper may be in a range of about 0.1 to about 0.35.

In an embodiment, the molar ratio of the halogen component to the Group III elements may be in a range of about 0.01 to about 0.7. For example, the molar ratio of the halogen component to the Group III elements may be in a range of about 0.02 to about 0.6. For example, the molar ratio of the halogen component to the Group III elements may be in a range of about 0.1 to about 0.5.

In an embodiment, the quantum dot 240 may be a quaternary compound that includes copper.

In an embodiment, the quantum dot 240 may include copper (Cu), indium (In), gallium (Ga), and sulfur(S).

According to an embodiment, with respect to a total weight of the quantum dot, an amount of copper may be in a range of about 10 wt % to about 40 wt %, an amount of indium may be in a range of about 10 wt % to about 30 wt %, an amount of gallium may be in a range of about 10 wt % to about 60 wt %, and an amount of sulfur may be in a range of about 30 wt % to about 60 wt %.

In an embodiment, the quantum dot 240 may be represented by CuInGaS₂.

In an embodiment, a maximum emission wavelength of the PL spectrum of the quantum dot 240 may be in a range of about 500 nm to about 750 nm. For example, the maximum emission wavelength of the PL spectrum of the quantum dot 240 may be in a range of about 585 nm to about 750 nm. For example, the maximum emission wavelength of the PL spectrum of the quantum dot 240 may be in a range of about 600 nm to about 720 nm.

According to an embodiment, the FWHM of the PL spectrum of the quantum dot 240 may be equal to or less than about 65 nm.

### [Method of Preparing Quantum Dot]

According to an embodiment, a method of preparing a quantum dot may include: providing a metal precursor solution including a copper halide, a Group III element halide, and a solvent; injecting a precursor of a Group VI element into the metal precursor solution; and preparing a quantum dot 240 including copper, a Group Ill element, and a Group VI element by reacting the metal precursor solution into which the precursor of the Group VI element injected.

The halides in the copper halide and the Group III element halide may each independently be an iodide ion, a bromide ion, a chloride ion, or a fluoride ion, such that the quantum dot 240 exhibits a PL spectrum having a maximum emission wavelength in a range of about 500 nm to about 750 nm and a FWHM equal to or less than about 80 nm, and a molar ratio of a halide component to copper of the quantum dot 240 and a molar ratio of a halide component to the Group III element of the quantum dot 240 prepared in this way may each independently be in a range of about 0.01 to about 0.5.

According to an embodiment, the Group III element may be aluminum (Al), gallium (Ga), indium (In), thallium (TI), or any combination thereof.

According to an embodiment, the Group III element halide may be AlI₃, AlBr₃, AlCl₃, AlF₃, GaI₃, GaBr₃, GaCl₃, GaF₃, InI₃, InBr₃, InCl₃, InF₃, TlI₃, TlBr₃, TlCl₃, TlF₃, or any combination thereof.

According to an embodiment, the copper halide may be CuI, CuBr, CuCl, CuF, or any combination thereof.

According to an embodiment, the Group III element halide may include two Group III element halides.

According to an embodiment, the two Group III element halides may each include a different Group III element.

According to embodiment, the two Group III elements may be indium (In) and gallium (Ga).

According to embodiment, the two Group III element halides may include InI₃, InBr₃, InCl₃, or InF₃; and GaI₃, GaBr₃, GaCl₃, GaF₃, or any combination thereof.

According to an embodiment, at least two of the three halides among the copper halide and the two Group III element halides may be different halides. According to an embodiment, in case that CuI is used as the copper halide, InI₃ and GaBr₃, InI₃ and GaCl₃, InI₃ and GaF₃, InBr₃ and GaI₃, InBr₃ and GaBr₃, InBr₃ and GaCl₃, InBr₃ and GaF₃, InCl₃ and GaI₃, InCl₃ and GaBr₃, InCl₃ and GaCl₃, InCl₃ and GaF₃, InF₃ and GaI₃, InF₃ and GaBr₃, InF₃ and GaCl₃, or InF₃ and GaF₃ may be used as the two Group III element halides. According to an embodiment, in case that CuBr is used as the copper halide, InI₃ and GaI₃, InI₃ and GaBr₃, InI₃ and GaCl₃, InI₃ and GaF₃, InBr₃ and GaI₃, InBr₃ and GaCl₃, InBr₃ and GaF₃, InCl₃ and GaI₃, InCl₃ and GaBr₃, InCl₃ and GaCl₃, InCl₃ and GaF₃, InF₃ and GaI₃, InF₃ and GaBr₃, InF₃ and GaCl₃, or InF₃ and GaF₃ may be used as the two Group III element halides. According to an embodiment, in case that CuCl is used as the copper halide, InI₃ and GaI₃, InI₃ and GaBr₃, InI₃ and GaCl₃, InI₃ and GaF₃, InBr₃ and GaI₃, InBr₃ and GaBr₃, InBr₃ and GaCl₃, InBr₃ and GaF₃, InCl₃ and GaI₃, InCl₃ and GaBr₃, InCl₃ and GaCl₃, InCl₃ and GaF₃, InF₃ and GaI₃, InF₃ and GaBr₃, InF₃ and GaCl₃, or InF₃ and GaF₃ may be used as the two Group III element halides. According to an embodiment, in case that CuF is used as the copper halide, InI₃ and GaI₃, InI₃ and GaBr₃, InI₃ and GaCl₃, InI₃ and GaF₃, InBr₃ and GaI₃, InBr₃ and GaBr₃, InBr₃ and GaCl₃, InBr₃ and GaF₃, InCl₃ and GaI₃, InCl₃ and GaBr₃, InCl₃ and GaCl₃, InCl₃ and GaF₃, InF₃ and GaI₃, InF₃ and GaBr₃, or InF₃ and GaCl₃ may be used as the two Group III element halides.

For example, a metal precursor for synthesizing the quantum dot 240 may include a combination of: CuI, InCl₃, and GaI₃; CuI, InI₃, and GaCl₃; CuI, InCl₃, and GaCl₃; CuBr, InI₃, and GaBr₃; CuBr, InI₃, and GaCl₃; CuCl, InCl₃, and GaCl₃; or CuCl, InF₃, and GaFl₃, but embodiments are not limited thereto.

The halogen component included in the quantum dot 240 may be present (or disposed) on a surface of the quantum dot. The halogen component may be derived from a metal halide, which is a metal precursor, in a process of preparing the quantum dot.

According to an embodiment, a solvent may include 1-octadecene (ODE), trioctylamine (TOA), trioctylphosphine (TOP), or a combination thereof, but embodiments are not limited thereto.

According to an embodiment, the Group VI element may be sulfur(S), selenium (Se), tellurium (Te), or any combination thereof.

According to an embodiment, the precursor of the Group VI element may be oleylamine (OLA) containing sulfur(S), selenium (Se), or tellurium (Te), ODE containing sulfur(S), selenium (Se), or tellurium (Te), or 1-dodecanethiol, or the like but embodiments are not limited thereto.

According to an embodiment, a maximum emission wavelength of a PL spectrum of the quantum dot 240 may be in a range of about 585 nm to about 750 nm.

According to an embodiment, a FWHM of the PL spectrum of the quantum dot 240 may be equal to or less than about 65 nm.

According to an embodiment, the quantum dot 240 may include copper (Cu), indium (In), gallium (Ga), and sulfur(S). For example, the quantum dot 240 may be a quantum dot 240 represented by CuInGaS₂.

Quantum dots including Group III-V or Group I-III-VI elements may be used as environmentally friendly non-cadmium-based materials. Since InP quantum dots, which are representative Group III-V quantum dots, have an insufficient blue light absorption rate, the blue light absorption rate may be increased by increasing a thickness of a quantum dot film, but quantum dot consumption may be large, and device efficiency may be reduced. Copper-based Group I-III-VI quantum dots have a high blue light absorption rate and are synthesized by using metal halide precursors to have a narrow emission FWHM. However, in case that a metal halide precursor including a same type of halide is used, although that an equivalent ratio of precursors of constituent metals is changed, a wavelength range of a PL spectrum, which is adjusted while a FWHM is maintained to be equal to or less than about 80 nm, is about 30 nm, which is very narrow. A range of a reaction temperature at which an emission wavelength may be controlled, may be limited to a small range.

According to embodiments, by changing a type of halide in metal halides that are precursors of metal components of a quantum dot, an emission wavelength may be adjusted across a wider range while a narrow FWHM is maintained. An emission wavelength of a quantum dot may be adjusted to a shorter wavelength by lowering an average atomic number of a halide used in metal halides, and the emission wavelength of the quantum dot may be adjusted to a longer wavelength by increasing an average atomic number of the halide.

In an embodiment, in case that indium iodide and gallium iodide are used as precursors to synthesize a quantum dot 240 including indium and gallium as Group III elements, a gallium component in the quantum dot 240 may increase, and an emission color of the quantum dot 240 may become closer to green. In another embodiment, in case that indium chloride and gallium chloride are used as precursors to synthesize a quantum dot 240 including indium and gallium as Group III elements, an indium component in the quantum dot 240 may increase, and an emission color of the quantum dot 240 may become closer to red. In another embodiment, in case that indium chloride and gallium iodide are used together as precursors, or in case that indium iodide and gallium chloride are used together, a quantum dot 240 may emit a color in a region between green and red. It is considered that a composition of each metal of a quantum dot 240 and a size of the quantum dot 240 are controlled by changing a type of halide in a metal halide.

### [Electronic Apparatus]

According to an embodiment, there may be provided an electronic apparatus (e.g., 200 in FIG. 1) including the quantum dot.

The quantum dot 240 may be included in various electronic apparatus. For example, the electronic apparatus including the quantum dot 240 may be a light-emitting apparatus, an authentication apparatus, or the like.

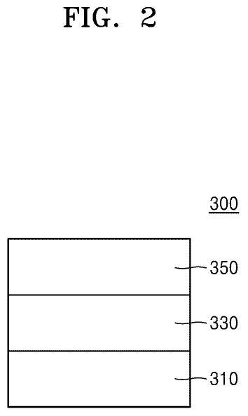

The electronic apparatus (for example, a light-emitting apparatus or a display apparatus) may further include a light-emitting device (e.g., 300 in FIG. 2), and a color filter, a color conversion layer, or a color filter and a color conversion layer. The color filter and/or the color conversion layer may be disposed in at least one traveling direction of light emitted from the light-emitting device. For example, light emitted from the light-emitting device may be blue light or white light. According to an embodiment, the light-emitting device may include quantum dots. According to an embodiment, the color conversion layer may include quantum dots. The quantum dot 240 may be, for example, the quantum dot 240 described herein.

The electronic apparatus may include a first substrate. The first substrate may include subpixel areas, the color filter may include color filter areas respectively corresponding to the subpixel areas, and the color conversion layer may include color conversion areas respectively corresponding to the subpixel areas.

A pixel defining film may be disposed between the subpixel areas to define each subpixel area.

The color filter may further include color filter areas and a light blocking pattern disposed between the color filter areas, and the color conversion layer may further include color conversion areas and a light blocking pattern disposed between the color conversion areas.

The color filter areas (or the color conversion areas) may include a first area that emits first color light, a second area that emits second color light, and/or a third area that emits third color light, and the first color light, the second color light, and/or the third color light may have different maximum emission wavelengths. For example, the first color light may be red light, the second color light may be green light, and the third color light may be blue light. For example, the color filter areas (or the color conversion areas) may include quantum dots. For example, the first area may include red quantum dots, the second area may include green quantum dots, and the third area may not include quantum dots. The quantum dot 240 may be formed in the first area and the second area. Each of the first area, the second area, and/or the third area may further include a scatterer.

For example, the light-emitting device may emit first light, the first area may absorb the first light to emit 1-1 color light, the second area may absorb the first light to emit 2-1 color light, and the third area may absorb the first light to emit 3-1 color light. For example, the 1-1 color light, the 2-1 color light and the 3-1 color light may have different maximum emission wavelengths. For example, the first light may be blue light, the 1-1 color light may be red light, the 2-1 color light may be green light, and the 3-1 color light may be blue light.

The electronic apparatus may further include a thin film transistor in addition to the light-emitting device described above. The thin film transistor may include a source electrode, a drain electrode, and an active layer, and any one of the source electrode and the drain electrode may be electrically connected to any one of a first electrode and a second electrode of the light-emitting device.

The thin film transistor may further include a gate electrode, a gate insulating film, and the like.

The active layer may include crystalline silicon, amorphous silicon, an organic semiconductor, an oxide semiconductor, or the like.

The electronic apparatus may further include a sealing portion that seals the light-emitting device. The sealing portion may be disposed between the color filter and/or color conversion layer and the light-emitting device. The sealing portion may allow light from the light-emitting device to be extracted to the outside and may simultaneously prevent ambient air and moisture from penetrating into the light-emitting device. The sealing portion may be a sealing substrate including a transparent glass substrate or a plastic substrate. The above sealing portion may be a thin film encapsulation layer including one or more organic layers and/or one or more inorganic layers. In case that the sealing portion is the thin film encapsulation layer, the electronic apparatus may be flexible.

On the sealing portion, in addition to the color filter and/or the color conversion layer, various functional layers may be additionally disposed according to the use of the electronic apparatus. Examples of the functional layers may include a touch screen layer, a polarizing layer, and the like. The touch screen layer may be a pressure-sensitive touch screen layer, a capacitive touch screen layer, or an infrared touch screen layer. The authentication apparatus may be, for example, a biometric authentication apparatus that authenticates an individual by using biometric information of a living body (for example, fingertips, pupils, or the like).

The authentication apparatus may further include a biometric information collection means in addition to the light-emitting device described above.

The electronic apparatus may be applied to various displays, light sources, lighting, personal computers (for example, a mobile personal computer), mobile phones, digital cameras, electronic organizers, electronic dictionaries, electronic game machines, medical instruments (for example, electronic thermometers, sphygmomanometers, blood glucose meters, pulse measurement apparatuses, pulse wave measurement apparatuses, electrocardiogram displays, ultrasonic diagnostic apparatuses, or endoscope displays), fish finders, various measuring instruments, meters (for example, meters for a vehicle, an aircraft, and a vessel), projectors, and the like.

According to an embodiment, there may be provided an electronic apparatus including a light source, and a color conversion member disposed on a path of light emitted from the light source. The quantum dot 240 may be included in the color conversion member.

FIG. 1 is a schematic cross-sectional view illustrating a structure of an electronic apparatus 200 according to the embodiment. The electronic apparatus 200 of FIG. 1 may include a substrate 210, a light source 220 disposed on the substrate, and a color conversion member 230 disposed on the light source 220.

For example, the light source 220 may be, a back light unit (BLU) used in a liquid crystal display (LCD), a fluorescent lamp, a light-emitting device, an organic light-emitting device, or a quantum dot light-emitting device (QLED), or a combination thereof, but embodiments are not limited thereto. The color conversion member 230 may be disposed in at least one traveling direction of light emitted from the light source 220.

At least one area of the color conversion member 230 of the electronic apparatus 200 may include the quantum dot, and the area may absorb light emitted from the light source to emit light having a maximum emission wavelength in a range of about 500 nm to about 750 nm.

For example, the fact that the color conversion member 230 is disposed in at least one traveling direction of light emitted from the light source 220 does not exclude that other elements may be further included between the color conversion member 230 and the light source 220.

For example, a polarizing plate, a liquid crystal layer, a light guide plate, a diffusion plate, a prism sheet, a microlens sheet, a luminance enhancement sheet, a reflective film, a color filter, or a combination thereof may be additionally disposed between the light source 220 and the color conversion member 230.

As another example, a polarizing plate, a liquid crystal layer, a light guide plate, a diffusion plate, a prism sheet, a microlens sheet, a luminance enhancement sheet, a reflective film, a color filter, or a combination thereof may be additionally disposed on the color conversion member 230.

Light emitted from the light source 220 as described above may be converted into light while passing through the quantum dot 240 in the color conversion member 230. For example, the quantum dot 240 may absorb first light emitted from the light source 220 and may emit visible light different from the first light. For example, the quantum dot 240 may absorb ultraviolet (UV) light emitted from the light source 220 and may emit visible light having a maximum emission wavelength of about 500 nm to about 750 nm. For another example, the quantum dot 240 may absorb blue light emitted from the light source 220 and may emit visible light having a maximum emission wavelength of about 500 nm to about 750 nm. Accordingly, the color conversion member 230 including the quantum dot 240 may be designed to absorb UV light or blue light emitted from the light source 220 to emit light with wavelengths in various color ranges.

For another example, the quantum dot 240 may absorb blue light emitted from the light source 220 and may emit green light having a maximum emission wavelength of about 500 nm to about 570 nm. As another example, the quantum dot 240 may absorb blue light emitted from the light source 220 and may emit red light having a maximum emission wavelength of about 630 nm to about 750 nm.

Accordingly, the quantum dot 240 or the color conversion member 230 including the quantum dot 240 may absorb light emitted from the light source 220 to implement green or red light at high luminance and high color purity.

The electronic apparatus 200 shown in FIG. 1 may be an example of an apparatus according to an embodiment, may have various known forms, and may additionally include various known components for this purpose.

According to another embodiment, the electronic apparatus 200 may have a structure in which a light source, a light guide plate, a color conversion member, a first polarizing plate, a liquid crystal layer, a color filter, and a second polarizing plate are sequentially disposed.

According to another embodiment, the electronic apparatus 200 may have a structure in which a light source, a light guide plate, a first polarizing plate, a liquid crystal layer, a second polarizing plate, and a color conversion member are sequentially disposed.

In the above embodiments, the color filter may include a pigment or a dye. In the above embodiments, one of the first polarizing plate and the second polarizing plate may be a vertical polarizing plate, and the other may be a horizontal polarizing plate.

For example, the quantum dot 240 as described herein may be used as an emitter. According to an embodiment, there may be provided a light-emitting device including a first electrode, a second electrode opposite to the first electrode, and an emission layer disposed between the first electrode and the second electrode and including the quantum dot. The light-emitting device may further include a hole transport region disposed between the first electrode and the emission layer, an electron transport region disposed between the emission layer and the second electrode, or a combination thereof.

FIG. 2 is a schematic cross-sectional view illustrating a structure of a light-emitting device 300 according to an embodiment of the disclosure. The light-emitting device 300 may include a first electrode 310, an intermediate layer 330, and a second electrode 350.

The intermediate layer 330 may be disposed on the first electrode 310. The intermediate layer 330 may include an emission layer.

The intermediate layer 330 may further include a hole transport region disposed between the first electrode 310 and the emission layer and an electron transport region disposed between the emission layer and the second electrode 350.

In addition to the quantum dot, the intermediate layer 330 may further include a metal-containing compound such as an organometallic compound, various organic materials, inorganic materials, or the like.

The hole transport region and the electron transport region may include a hole transport material and/or an electron transport material commonly used in organic light-emitting devices or QLEDs.

Meanwhile, the intermediate layer 330 may include two or more light-emitting units stacked between the first electrode 310 and the second electrode 350, and at least one charge generation layer disposed between adjacent units among the two or more light-emitting units. In case that the intermediate layer 330 includes the two or more light-emitting units and the at least one charge generation layer as described above, the light-emitting device 300 may be a tandem light-emitting device.

The emission layer may have a structure of a single quantum dot layer or may have a structure in which two or more quantum dot layers are stacked.

The emission layer may include the quantum dot 240 as described herein.

The emission layer may further include a quantum dot that is different from the quantum dot 240 as described herein.

In addition to the quantum dot 240 described herein, the emission layer may further include a dispersion medium in which the quantum dots are dispersed in a naturally coordinated form. The dispersion medium may include an organic solvent, a polymer resin, or a combination thereof. Any transparent medium may be used as the dispersion medium as long as the transparent medium does not affect the optical performance of the quantum dot, is not deteriorated by light, and does not absorb light. For example, the organic solvent may include toluene, chloroform, ethanol, octane, or a combination thereof, and the polymer resin may include an epoxy resin, a silicone resin, a polystyrene resin, an acrylate resin, or a combination thereof.

In an embodiment, the emission layer may be formed by applying an emission layer-forming composition including quantum dots onto a hole transport region and volatilizing at least a portion of a solvent included in the emission layer-forming composition.

For example, water, hexane, chloroform, toluene, octane, or the like may be used as the solvent included in the emission layer-forming composition.

The emission layer-forming composition may be applied by using a spin coating process, a casting process, a micro-gravure coating process, a gravure coating process, a bar coating process, a roll coating process, a wire bar coating process, a dip coating process, a spray coating process, a screen printing process, a flexographic printing process, an offset printing process, an inkjet printing process, or the like.

In case that the light-emitting device 300 is a full-color light-emitting device, the emission layer may include emission layers that emit pieces of light having different colors for each individual subpixel.

For example, the emission layer may be patterned into a first color emission layer, a second color emission layer, and a third color emission layer for each individual subpixel. For example, at least one emission layer of the above-described emission layers may include quantum dots. For example, the first color emission layer may be a quantum dot emission layer including quantum dots, and the second color emission layer and the third color emission layer may each be an organic emission layer including an organic compound. For example, first to third colors may be different colors. For example, pieces of light having the first to third colors may have different maximum emission wavelengths. The first to third colors may be combined with each other to become a white color.

As another example, the emission layer may further include a fourth color emission layer. Variously modifications may be possible in which at least one emission layer of the first to fourth color emission layers is a quantum dot emission layer including quantum dots, and the remaining emission layers thereof may be each an organic emission layer including an organic compound. Here, first to fourth colors are different colors. For example, pieces of light having the first to fourth colors may have different maximum emission wavelengths. The first to fourth colors may be combined with each other to become a white color.

In another example, the light-emitting device 300 may have a structure in which two or more emission layers emitting pieces of light having the same or different colors are stacked to be in contact with or spaced apart from each other. Various modifications may be possible in which at least one emission layer of the two or more emission layers is a quantum dot emission layer including quantum dots, and the remaining emission layers thereof are organic emission layers including an organic compound. For example, the light-emitting device 300 may include a first color emission layer and a second color emission layer. For example, first color and second color may be the same color or different colors. For example, both the first color and the second color may be a green color.

In addition to the quantum dot, the emission layer may further include at least one selected from an organic compound and a compound.

For example, the organic compound may include a host and a dopant. The host and the dopant may include a host and a dopant commonly used in organic light-emitting devices.

Hereinafter, a quantum dot 240 and a method of preparing the quantum dot 240 according to an embodiment of the disclosure will be described in more detail through Examples.

### TEST EXAMPLES

### Synthesis of CuInGaS₂ Quantum Dots

### Comparative Test Example 1

About 0.3 mmol of CuI, about 0.6 mmol of InI₃, and about 0.37 mmol of GaI₃ may be added into a three-neck flask, mixed with about 10 ml of OLA, and about 10 ml of 1-ODE therein, and degassing and stirring may be performed at a temperature of about 120° C. for about 30 minutes to prepare a reaction solution.

About 2.0 mmol of sulfur-OLA and about 4.8 mmol of 1-dodecanethiol may be added to the reaction solution in a nitrogen (N₂) atmosphere, a temperature may be raised to about 230° C., maintained for about 4 hours, and cooled to room temperature to synthesize CuInGaS₂ quantum dots.

The synthesized CuInGaS₂ quantum dots may be diluted in toluene and precipitated with ethanol for purification.

### Comparative Test Examples 2 to 4

CuInGaS₂ quantum dots may be synthesized and purified in the same manner as in Comparative Test Example 1, except that amounts of CuI, InI₃, and GaI₃ shown in Table 1 may be used instead of about 0.3 mmol of CuI, about 0.6 mmol of InI₃, and about 0.37 mmol of GaI₃.

### Test Examples 1 to 5

CuInGaS₂ quantum dots may be synthesized and purified in the same manner as in Comparative Test Example 1, except that, instead of using about 0.3 mmol of CuI, about 0.6 mmol of InI₃, and about 0.37 mmol of GaI₃, precursors (moles) shown in Table 2 may be used as a Cu precursor (CuX), an In precursor (InY₃), and a Ga precursor (GaZ₃), respectively.

### Test Examples 6 to 9

CuInGaS₂ quantum dots may be synthesized and purified in the same manner as in Comparative Test Example 1, except that, instead of using about 0.3 mmol of CuI, about 0.6 mmol of InI₃, and about 0.37 mmol of GaI₃, precursors (moles) shown in Table 3 may be used as a Cu precursor (CuX), an In precursor (InY₃), and a Ga precursor (GaZ₃), respectively.

### Evaluation of Quantum Dot Luminescence Properties

For the CuInGaS₂ quantum dots of Test Examples 1 to 9 and Comparative Test Examples 1 to 4, about 0.2 ml of the quantum dots may be dispersed in about 2.8 ml of toluene in a quartz cuvette, and a maximum emission wavelength and a FWHM of the quantum dots may be measured by using a photoluminescence (PL) spectrometer (e.g., FluoroMax manufactured by Horiba) and a Ultraviolet-Visible (UV-VIS) spectrometer (e.g., Lambda 365+ manufactured by PerkinElmer, Inc.). For example, a wavelength of excitation light may be about 450 nm.

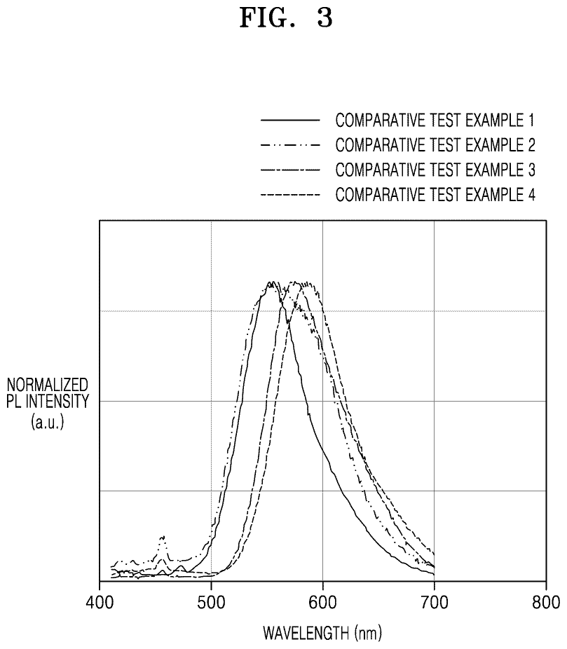

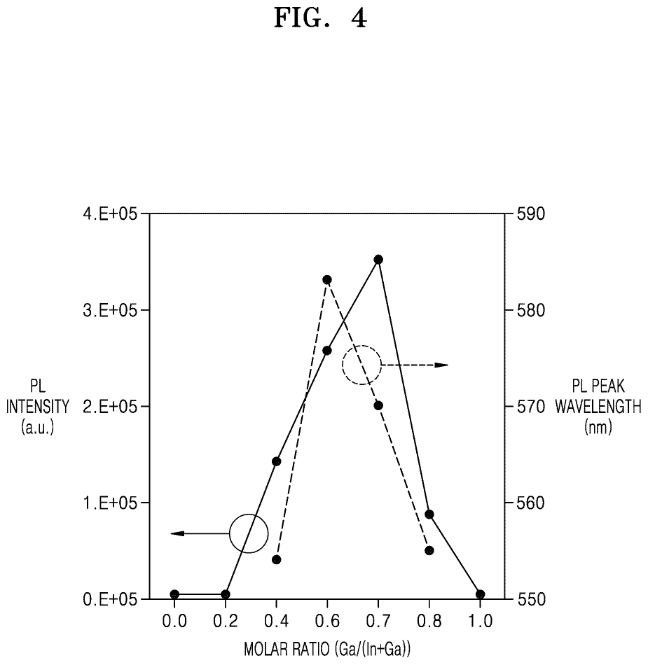

FIG. 3 is a graph showing PL spectra of the CuInGaS₂ quantum dots prepared in Comparative Test Examples 1 to 4. FIG. 4 is a graph showing intensity (PL intensity) and a peak position (PL peak position) of the PL spectra of FIG. 3 according to a molar ratio of Ga to In+Ga in the quantum dots. A composition ratio of Ga to In+Ga may be obtained through inductively coupled plasma (ICP) analysis of the quantum dots. The intensity of the PL spectrum may reflect luminescence efficiency. Table 1 shows a maximum emission wavelength of the CuInGaS₂ quantum dots of Comparative Test Examples 1 to 4 along with the molar ratio of Ga to In+Ga. The molar ratio of Ga to In+Ga may be obtained by performing inductive coupled plasma mass spectrometry (ICP-MS) analysis using 7850 ICP-MS equipment, which is manufactured by Agilent technologies.

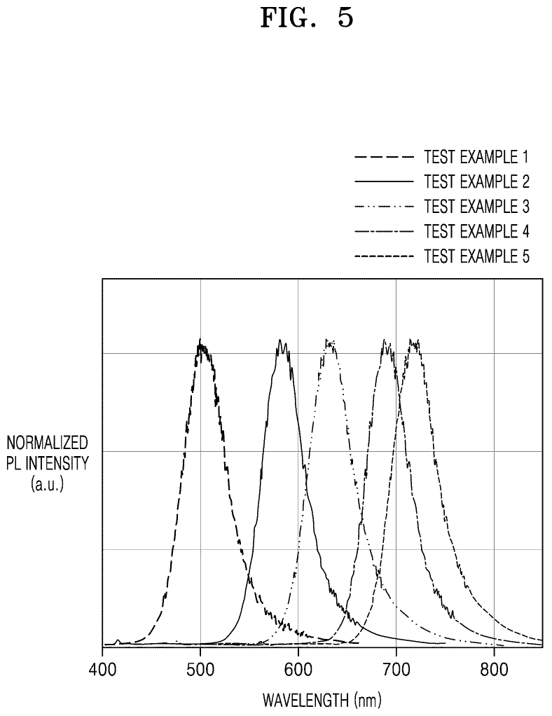

FIG. 5 shows PL spectra of the CuInGaS₂ quantum dots prepared in Test Examples 1 to 5. Table 2 shows a maximum emission wavelength and a FWHM of the CuInGaS₂ quantum dots of Test Examples 1 to 5 along with a molar ratio of a halogen component to a metal component. The halogen component may be the sum of all halogen components included in the quantum dot, and the metal component may be the sum of all metal components included in the quantum dot 240 (e.g., the sum of Cu, In, and Ga).

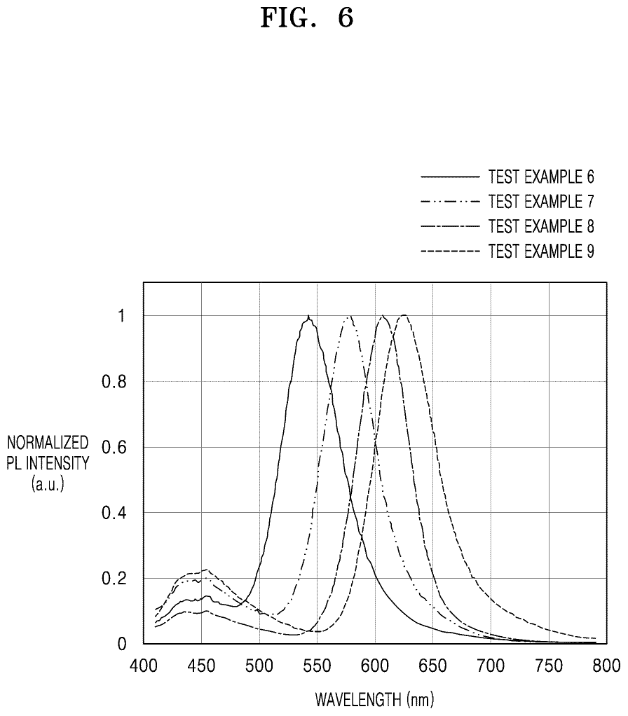

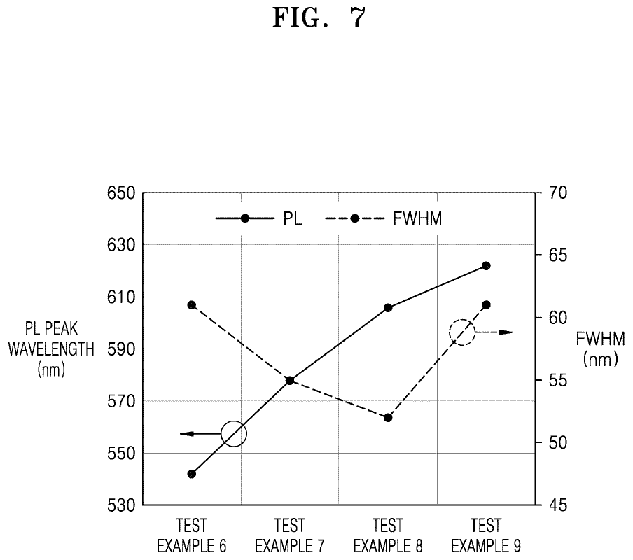

FIG. 6 shows PL spectra for the CuInGaS₂ quantum dots prepared in Test Examples 6 to 9. Table 3 shows a maximum emission wavelength and a FWHM of the CuInGaS₂ quantum dots of Test Examples 6 to 9 along with a molar ratio of a halogen component to a metal component. FIG. 7 is a graph showing a maximum emission wavelength and a FWHM of the PL spectra of Test Examples 6 to 9 for a set of metal precursors.

The molar ratio of the halogen component to the metal component may be obtained by performing X-ray photoelectron spectroscopy (XPS) analysis using Nexsa G2 (Thermofisher) equipment.

TABLE 1

| | | | | Maximum | |
|---|---|---|---|---|---|
| | | | | emission | |
| | CuI | InI₃ | GaI₃ | wavelength | Ga/ |
| | (mmol) | (mmol) | (mmol) | (nm) | (In + Ga) |
| Comparative | 0.3 | 0.6 | 0.37 | 553 | 0.38 |
| Test Example 1 | | | | | |
| Comparative | 0.3 | 0.48 | 0.6 | 583 | 0.56 |
| Test Example 2 | | | | | |
| Comparative | 0.3 | 0.35 | 0.7 | 570 | 0.67 |
| Test Example 3 | | | | | |
| Comparative | 0.3 | 0.2 | 0.7 | 554 | 0.78 |
| Test Example 4 | | | | | |

TABLE 2

| | CuX | InY₃ | GaZ₃ | Maximum | | (X + Y + | |
|---|---|---|---|---|---|---|---|
| | (0.32 | (0.7 | (1.8 | emission | FWHM | Z)/(Cu + | (X + Y + |
| | mmol) | mmol) | mmol) | wavelength (nm) | (nm) | In + Ga) | Z)/Cu |
| Test Example 1 | CuI | InI₃ | GaI₃ | 506 | 60 | 0.01 | 0.02 |
| Test Example 2 | CuBr | InI₃ | GaBr₃ | 587 | 46 | 0.07 | 0.14 |
| Test Example 3 | CuBr | InI₃ | GaCl₃ | 635 | 61 | 0.08 | 0.15 |
| Test Example 4 | CuCl | InCl₃ | GaCl₃ | 692 | 50 | 0.15 | 0.18 |
| Test Example 5 | CuCl | InF₃ | GaF₃ | 723 | 54 | 0.2 | 0.34 |

TABLE 3

| | CuX | InY₃ | GaZ₃ | Maximum | | (X + Y + | |
|---|---|---|---|---|---|---|---|
| | (0.34 | (0.8 | (1.6 | emission | FWHM | Z)/(Cu + | (X + Y + |
| | mmol) | mmol) | mmol) | wavelength (nm) | (nm) | In + Ga) | Z)/Cu |
| Test Example 6 | CuI | InI₃ | GaI₃ | 540 | 61 | 0.02 | 0.05 |
| Test Example 7 | CuBr | InCl₃ | GaBr₃ | 575 | 54 | 0.08 | 0.15 |
| Test Example 8 | CuBr | InI₃ | GaCl₃ | 608 | 52 | 0.12 | 0.22 |
| Test Example 9 | CuCl | InCl₃ | GaCl₃ | 620 | 61 | 0.18 | 0.34 |

For sets of Comparative Test Examples 1 to 4, referring to FIGS. 3 and 4 and Table 1, the molar ratio of Ga to In+Ga of the CuInGaS₂ quantum dots may be in a range of about 0.38 to about 0.78 which is wide, but a range of the maximum emission wavelength of the PL spectrum may be about 30 nm between about 553 nm and about 583 nm, which is narrow. As the molar ratio of Ga to In+Ga increases, the intensity of the PL spectrum may increase to about 0.67 and then decrease to about 0.78. As the molar ratio of Ga to In+Ga increases, the maximum emission wavelength may increase to about 0.56 and then decrease.

For sets of Test Examples 1 to 5, referring to FIG. 5 and Table 2, the maximum emission wavelength of the PL spectrum of the quantum dots of Test Example 1, in which CuI, InI₃, and GaI₃ are used as metal precursors, may be about 506 nm, and the maximum emission wavelength of the PL spectrum of the quantum dots of Test Example 5, in which CuCl, InF₃, and GaF₃ are used as metal precursors, may be about 723 nm so that a range of the maximum emission wavelength may be 217 nm. In the sets of Test Examples 1 to 5, the range of the maximum emission wavelengths of the quantum dots may be about 7 times or more wider than the range of the maximum emission wavelength of the PL spectrum which is about 30 nm in the sets of Comparative Test Examples 1 to 4.

Referring to FIGS. 6 and 7 and Table 3 for sets of Test Examples 6 to 9, the maximum emission wavelength of the PL spectrum of the quantum dots of Test Example 6, in which CuI, InI₃, and GaI₃ are used as metal precursors, may be about 540 nm, the maximum emission wavelength of the PL spectrum of the quantum dots of Test Example 9, in which CuI, InCl₃, and GaCl₃ are used as metal precursors, may be about 620 nm so that a range of the maximum emission wavelength may be about 80 nm. The range of about 80 nm of the maximum emission wavelength may be wider by at least a factor of 2 than the range of about 30 nm of the maximum emission wavelength in the sets of Comparative Test Examples 1 to 4. Referring to FIG. 7, in Test Example 6, in case that iodine is used as halogen components of all of three types of metal precursors, a wavelength of an emission peak may be the shortest, and as the number of metal precursors including chlorine as a halogen component increases, the wavelength of the emission peak may be longer. Such a trend may be also observed in the sets of Test Examples 1 to 5. Referring again to FIG. 5 and Table 1, as the number of metal halides including halides with lower atomic numbers increases, a maximum emission wavelength may become longer.

Referring to Tables 2 and 3, a halogen component may be detected in the CuInGaS₂ quantum dots in Test Examples 1 to 9 and may be considered to be derived from a metal halide precursor. XPS measurements show that the halogen component is present on a surface of the quantum dot.

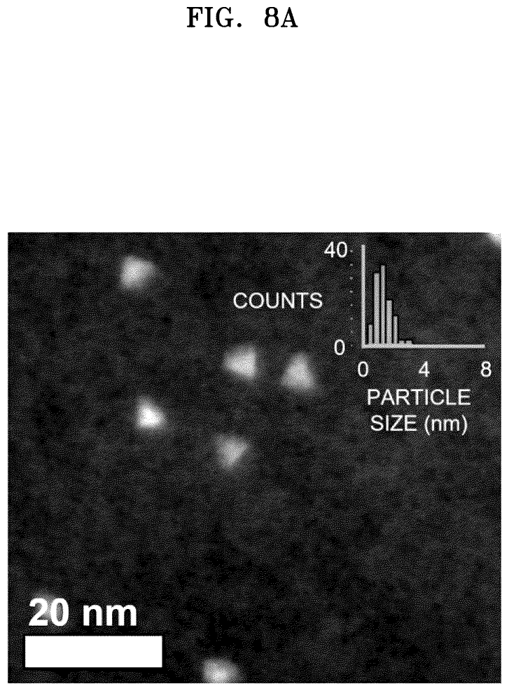

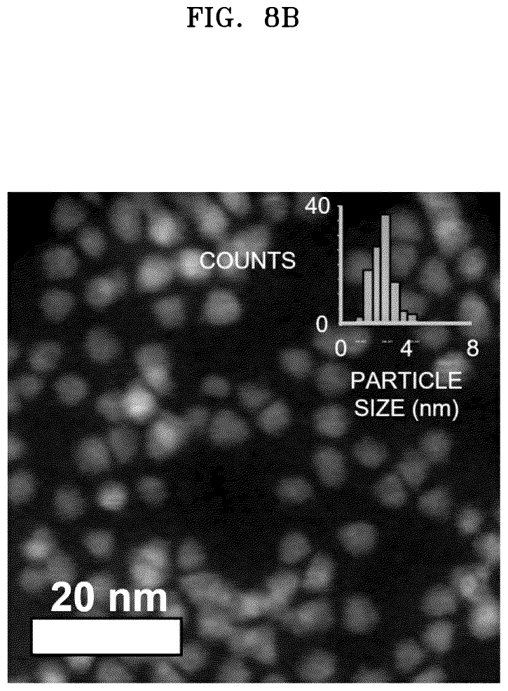

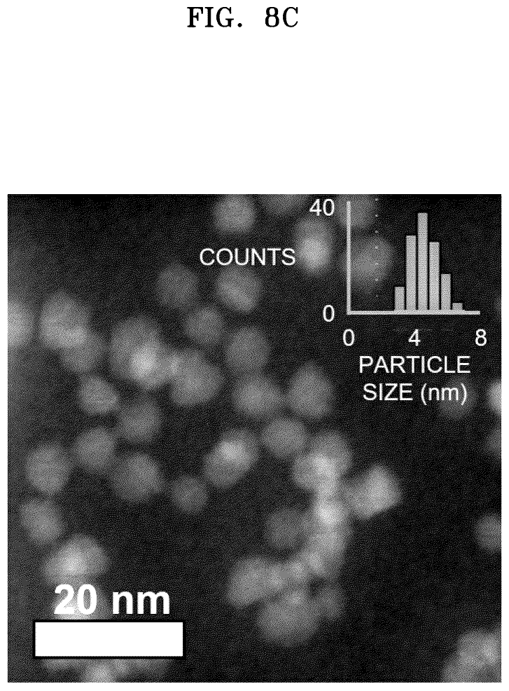

FIGS. 8A to 8C show transmission electron microscope (TEM) images of the CuInGaS₂ quantum dots of Test Examples 7 to 9, respectively. The TEM images may be obtained by using JEM-ARM300F2 equipment, which is manufactured by JEOL Ltd. A graph included in the upper right of FIGS. 8A to 8C is a histogram showing a distribution of particle sizes analyzed through a TEM. The X-axis of the graph shows the particle size, and the Y-axis shows the number of particles. Referring to FIGS. 8A to 8C, a size of the quantum dots may gradually increase in the order of Test Examples 7 to 9.

From the PL spectra of the Comparative Test Examples 1 to 4, Test Examples 1 to 5, and Test Examples 6 to 9, it may be seen that types of halogens in a metal precursor, which is used for synthesizing the CuInGaS₂ quantum dots, are adjusted, thereby widely adjusting the emission wavelength of the quantum dots while having a FWHM equal to or less than 80 nm.

The quantum dots may have a desired emission wavelength in a wide range while maintaining a narrow FWHM.

In concluding the detailed description, those skilled in the art will appreciate that many variations and modifications may be made to the embodiments without substantially departing from the principles and spirit and scope of the disclosure. Therefore, the disclosed embodiments are used in a generic and descriptive sense only and not for purposes of limitation.

What is claimed is:

1. A quantum dot, comprising:
copper (Cu);
a Group III element; and
a Group VI element, wherein
the quantum dot further comprises a halogen component that is an iodide ion, a bromide ion, a chloride ion, a fluoride ion, or a combination thereof,
a molar ratio of the halogen component to the Cu and a molar ratio of the halogen component to the Group III element is each independently in a range of about 0.01 to about 0.5, and
a full width at half maximum (FWHM) of a photoluminescence spectrum of the quantum dot is equal to or less than about 80 nm.

2. The quantum dot of claim 1, wherein the Group III element is aluminum (Al), gallium (Ga), indium (In), thallium (TI), nihonium (Nh), or a combination thereof.

3. The quantum dot of claim 1, wherein the Group VI element is sulfur(S), selenium (Se), tellurium (Te), or a combination thereof.

4. The quantum dot of claim 1, wherein the halogen component comprises at least two halogen ions selected from an iodide ion, a bromide ion, a chloride ion, and a fluoride ion.

5. The quantum dot of claim 1, wherein a molar ratio of the halogen component to the Cu is in a range of about 0.02 to about 0.4.

6. The quantum dot of claim 1, wherein a molar ratio of the halogen component to the Group III element is in a range of about 0.02 to about 0.5.

7. The quantum dot of claim 1, wherein the quantum dot comprises copper (Cu), indium (In), gallium (Ga), and sulfur(S).

8. The quantum dot of claim 7, wherein with respect to a total weight of the quantum dot,
an amount of the Cu is in a range of about 10 wt % to about 40 wt %,
an amount of the In is in a range of about 10 wt % to about 30 wt %,
an amount of the Ga is in a range of about 10 wt % to about 60 wt %, and
an amount of the S is in a range of about 30 wt % to about 60 wt %.

9. The quantum dot of claim 1, wherein a maximum emission wavelength of the photoluminescence spectrum is in a range of about 500 nm to about 750 nm.

10. The quantum dot of claim 1, wherein a maximum emission wavelength of the photoluminescence spectrum is in a range of about 585 nm to about 750 nm.

11. The quantum dot of claim 1, wherein the FWHM of the photoluminescence spectrum of the quantum dot is equal to or less than about 65 nm.

12. A method of preparing a quantum dot, the method comprising:
providing a metal precursor solution comprising a copper halide, a Group III element halide, and a solvent;
injecting a precursor of a Group VI element into the metal precursor solution; and
preparing a quantum dot comprising copper, a Group III element, and a Group VI element by reacting the metal precursor solution into which the precursor of the Group VI element is injected, wherein
the halides in the copper halide and the Group III element halide are each independently an iodide ion, a bromide ion, a chloride ion, or a fluoride ion, such that the quantum dot exhibits a photoluminescence spectrum having a maximum emission wavelength in a range of about 500 nm to about 750 nm and a full width at half maximum (FWHM) equal to or less than about 80 nm, and
a molar ratio of a halide component to the copper of the quantum dot and a molar ratio of a halide component to the Group III element of the quantum dot is each independently in a range of about 0.01 to about 0.5.

13. The method of claim 12, wherein the Group III element halide comprises two Group III element halides, each comprising a different Group III element.

14. The method of claim 13, wherein
at least two halides among the copper halide and the two Group III element halides are different halides.

15. The method of claim 13, wherein
the two Group III element halides are an indium (In) halide and a gallium halide, respectively, and
the Group VI element is sulfur(S), selenium (Se), tellurium (Te), or a combination thereof.

16. The method of claim 12, wherein a maximum emission wavelength of the photoluminescence spectrum of the quantum dot is in a range of about 585 nm and about 750 nm.

17. The method of claim 12, wherein the FWHM of the photoluminescence spectrum of the quantum dot is equal to or less than about 65 nm.

18. The method of claim 12, wherein the quantum dot comprises copper (Cu), indium (In), gallium (Ga), and sulfur(S).

19. An electronic apparatus comprising the quantum dot of claim 1.

20. The electronic apparatus of claim 19, further comprising:
a light source; and
a color conversion member disposed on a path of light emitted from the light source, wherein
the color conversion member includes the quantum dot.
